(19) United States
(12) Patent Application Publication
(10) Pub. No.: US 2025/0149548 A1
(43) Pub. Date: May 8, 2025

(54) ACTIVE MATERIAL SECONDARY PARTICLE, ELECTRODE MIXTURE, BATTERY, AND MANUFACTURING METHOD FOR ACTIVE MATERIAL SECONDARY PARTICLE

(71) Applicant: TOYOTA JIDOSHA KABUSHIKI KAISHA, Toyota-shi (JP)

(72) Inventors: So YUBUCHI, Sunto-gun (JP); Shohei KAWASHIMA, Susono-shi (JP)

(73) Assignee: TOYOTA JIDOSHA KABUSHIKI KAISHA, Toyota-shi (JP)

(21) Appl. No.: 18/915,549

(22) Filed: Oct. 15, 2024

(30) Foreign Application Priority Data
Nov. 2, 2023 (JP) 2023-188784

(51) Int. Cl. H01M 4/36; H01M 4/02; H01M 4/525; H01M 10/0562

(52) U.S. Cl. CPC H01M 4/364; H01M 4/525; H01M 10/0562; H01M 2004/021; H01M 2004/028; H01M 2300/0068

(57) ABSTRACT

Disclosed is an active material having an O2-type structure and having high capacity and low resistance. The active material secondary particle of the present disclosure comprises a plurality of primary particles and a Li-ion conducting material. The plurality of primary particles have an O2-type structure. A particle diameter of the plurality of primary particles is 1.5 μm or less. The plurality of primary particles are joined to each other via the Li-ion conducting material.

### FIELD

The present application discloses an active material secondary particle, an electrode mixture, a battery, and a manufacturing method for an active material secondary particle.

### BACKGROUND

Active materials for batteries having an O2-type structure (O: Octahedral) are known. As disclosed in PTL 1, an active material having an O2-type structure can be obtained by subjecting at least a portion of Na in a Na-containing oxide having a P2-type structure to ion exchange with Li.

### CITATION LIST

### Patent Literature

[PTL 1] Japanese Unexamined Patent Publication (Kokai) No. 2010-092824

### SUMMARY

### Technical Problem

Active materials having an O2-type structure have room for improvement in terms of capacity and resistance.

### Solution to Problem

The present application discloses the following plurality of aspects as means for achieving the above object.

### <Aspect 1>

An active material secondary particle, comprising a plurality of primary particles and a Li-ion conducting material, wherein
the plurality of primary particles have an O2-type structure,
a particle diameter of the plurality of primary particles is 1.5 μm or less, and
the plurality of primary particles are joined to each other via the Li-ion conducting material.

### <Aspect 2>

The active material secondary particle according to Aspect 1, wherein
a ratio M2/M1 of a mass M2 of the Li-ion conducting material relative to a mass M1 of the primary particles is 0.01 or greater and 0.20 or less.

<Aspect 3>

The active material secondary particle according to Aspect 1 or 2, wherein
at least a portion of the plurality of the primary particles are tabular particles.

### <Aspect 4>

The active material secondary particle according to any of Aspects 1 to 3, wherein
a particle diameter of the active material secondary particle is 3 μm or more and 25 μm or less.

### <Aspect 5>

The active material secondary particle according to any of Aspects 1 to 4, wherein
the Li-ion conducting material is an inorganic compound.

### <Aspect 6>

The active material secondary particle according to Aspect 5, wherein
the inorganic compound is a Li-containing oxide.

### <Aspect 7>

An electrode mixture, comprising
the active material secondary particle according to any of Aspects 1 to 6, and a solid electrolyte.

### <Aspect 8>

The electrode mixture according to Aspect 7, wherein
the solid electrolyte comprises a sulfide solid electrolyte.

### <Aspect 9>

A battery, comprising a positive electrode active material layer, an electrolyte layer, and a negative electrode active material layer, wherein
the positive electrode active material layer comprises the active material secondary particle according to any of Aspects 1 to 6.

### <Aspect 10>

The battery according to Aspect 9, wherein
the electrolyte layer comprises a solid electrolyte.

### <Aspect 11>

A manufacturing method for an active material secondary particle, comprising
joining a plurality of primary particles via a Li-ion conducting material to form a secondary particle, wherein
   the plurality of primary particles have an O2-type structure, and
   a particle diameter of the plurality of primary particles is 1.5 μm or less.

### <Aspect 12>

The manufacturing method for an active material secondary particle according to Aspect 11, comprising
preparing a solution in which the Li-ion conducting material is dissolved, and
bringing the solution into contact with the plurality of primary particles, followed by drying, thereby joining the plurality of primary particles via the Li-ion conducting material to form a secondary particle.

### Effects

The active material secondary particle of the present disclosure has high capacity and low resistance.

### BRIEF DESCRIPTION OF DRAWINGS

FIG. 1 schematically shows one example of a configuration of the inside (cross-section) of an active material secondary particle.

FIG. 2 schematically shows one example of the flow of a manufacturing method for an active material secondary particle.

FIG. 3 schematically shows one example of a configuration of an electrode mixture.

FIG. 4 schematically shows one example of a configuration of a battery.

FIG. 5 is a SEM image of active material secondary particles according to Example 6.

### DESCRIPTION OF EMBODIMENTS

Hereinafter, one embodiment of each of the active material secondary particle, the electrode mixture, the battery, and the manufacturing method for an active material secondary particle of the present disclosure will be described. However, the active material secondary particle, the electrode mixture, the battery, and the manufacturing method for an active material secondary particle of the present disclosure are not limited to the embodiments described below.

### 1. Active Material Secondary Particle

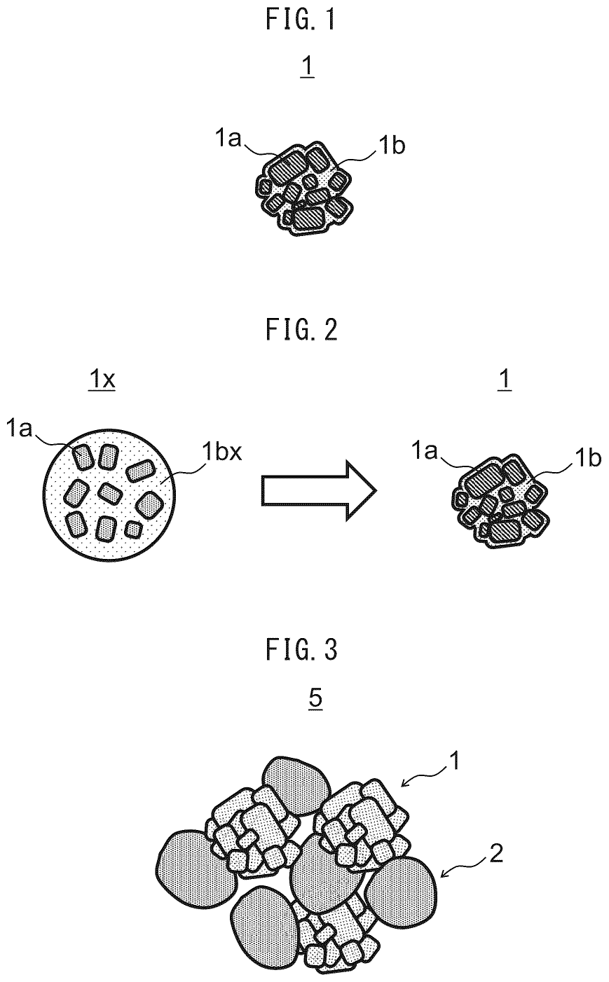

As shown in FIG. 1, the active material secondary particle 1 according to one embodiment comprises a plurality of primary particles 1a and a Li-ion conducting material 1b. The plurality of primary particles 1a have an O2-type structure. A particle diameter of the plurality of primary particles 1a is 1.5 μm or less. The plurality of primary particles 1a are joined to each other via the Li-ion conducting material 1b.

### 1.1 Primary Particle

### 1.1.1 Crystal Structure

The primary particle 1a according to one embodiment may have a crystal structure other than an O2-type structure, in addition to having an O2-type structure. Examples of crystal structures other than an O2-type structure include a T #2-type structure (belonging to space group Cmca) and an O6-type structure (belonging to space group R-3m, with a c-axis length of 2.5 nm or more and 3.5 nm or less, typically 2.9 nm or more and 3.0 nm or less, and differing from an O3-type structure belonging to the same space group R-3m), formed when Li is deintercalated from an O2-type structure. The primary particle 1a according to one embodiment may have an O2-type structure as the main phase or may have a crystal structure (for example, 06-type structure) other than an O2-type structure as the main phase. The primary particle 1a according to one embodiment can have, depending on the charge and discharge states thereof, a crystal structure for the main phase that changes. The primary particle 1a according to one embodiment may be a single crystal consisting of one crystallite, or may be a polycrystal having a plurality of crystallites. Particularly, in the case of a single crystal, the particle diameter described below is easily satisfied.

### 1.1.2 Particle Diameter

O2-type active materials have room for improvement in terms of ion conduction paths within the active material and between active materials. Particularly, when an O2-type active material and a solid electrolyte are combined, resistance easily increases, and sufficient capacity may be difficult to demonstrate. In response thereto, fine particles as primary particles 1a having an O2-type structure are adopted, and the primary particles 1a are joined to each other via the Li-ion conducting material 1b described below to form a secondary particle, thereby appropriately ensuring ion conduction paths within the active material and between active materials. For example, when the active material secondary particle 1 is combined with a solid electrolyte, the resistance is likely decreased and sufficient capacity is easily demonstrated. According to the findings of the present inventors, such an effect can be significantly demonstrated by having a particle diameter of 1.5 μm or less for a plurality of primary particles 1a. The smaller the particle diameter, the more significant such an effect. The particle diameter may be more than 0 μm and 1.5 μm or less, more than 0 μm and 1.0 μm or less, or 0.1 μm or more and 0.5 μm or less.

The “particle diameter of primary particles” is an “average particle diameter” of a plurality of primary particles 1a constituting an active material secondary particle 1. The “average particle diameter” of a plurality of primary particles can be determined by observing the exterior of an active material secondary particle 1 with a scanning electron microscope (SEM) or a transmission electron microscope (TEM). Specifically, a two-dimensional image of an active material secondary particle 1 is acquired with SEM, and of the plurality of primary particles constituting the active material secondary particle 1 contained in the two-dimensional image, the area of each of any 10 primary particles is determined, each area is converted into a circle to determine the equivalent circular diameter of each of the primary particles, and a numerical average (arithmetic mean) value of the equivalent circular diameters is designated as the “average particle diameter”.

### 1.1.3 Shape

The primary particle 1a according to one embodiment, as described below, can be obtained by substituting Na in a Na-containing oxide having a P2-type structure with Li. The P2-type structure has a hexagonal crystal system and a large Na ion diffusion coefficient, and crystals are easily grown in a specific direction. Particularly, when a transition metal element constituting the P2-type structure includes at least one of Mn, Ni, and Co, tabular crystals are grown easily in a specific direction. Therefore, a Na-containing oxide having a P2-type structure easily forms into tabular crystals having a large aspect ratio, wherein crystal growth direction is biased in a specific direction. The primary particle 1a according to one embodiment may be obtained based on such a tabular Na-containing oxide particle, or may be obtained based on a spherical Na-containing oxide particle. Specifically, the shape of the primary particle 1a may be of a tabular particle, may be of a spherical particle, or may be indeterminate. According to the findings of the present inventors, when at least a portion of a plurality of primary particles 1a constituting an active material secondary particle 1 are tabular particles, capacity is further improved and resistance is likely to be lower.

A “tabular particle” in the present application refers to a particle having an aspect ratio of 1.5 or greater and 10 or less. The “aspect ratio” of a primary particle 1a is measured as described below. Specifically, a cross-section (may be a cross-section of a positive electrode active material layer when a secondary particle is contained in the positive electrode active material layer described below) of an active material secondary particle is observed with a scanning electron microscope (SEM) or a transmission electron microscope (TEM), and the shape of the primary particles contained in the active material secondary particle is identified. In the shape, the maximum Feret diameter is determined and regarded as a “long diameter”. In addition, in the shape, the largest diameter orthogonal to the “long diameter” is regarded as a “short diameter”. The ratio (long diameter/short diameter) of the “long diameter” to the “short diameter” is regarded as the “aspect ratio” of the primary particle 1a.

A “spherical particle” means a particle having a circularity of 0.80 or greater. The circularity of the spherical particle may be 0.81 or greater, 0.82 or greater, 0.83 or greater, 0.84 or greater, 0.85 or greater, 0.86 or greater, 0.87 or greater, 0.88 or greater, 0.89 or greater, or 0.90 or greater. The circularity of a particle is defined as 4πS/L², where S is the orthographic area of the particle and L is the circumference of an orthographic image of the particle. The circularity of a particle can be determined by observing the exterior of the particle with a scanning electron microscope (SEM), a transmission electron microscope (TEM), or an optical microscope.

### 1.1.4 Chemical Composition

The chemical composition of the primary particle 1a is not particularly limited as long as the O2-type structure is maintained. The primary particle 1a, for example, may at least comprise, as constituent elements, at least one element among Mn, Ni, and Co; Li; and O. In the primary particle 1a, particularly when at least Li, Mn, one or both of Ni and Co, and O are included as constituent elements, especially when at least Li, Mn, Ni, Co, and O are included as constituent elements, higher performance is easily obtained.

The primary particle 1a may have a chemical composition represented by LiₐNa_{b}Mnₓ₋ₚNi_{y-q}Co_{z-r}M_{p+q+r}O₂ (where 0<a≤1.00; 0≤b≤0.20; x+y+z=1; and 0≤p+q+r<0.17, and the element M is at least one selected from B, Mg, Al, K, Ca, Ti, V, Cr, Fe, Cu, Zn, Ga, Ge, Sr, Y, Zr, Nb, Mo, and W). When the primary particle 1a has such a chemical composition, an O2-type structure is easily maintained. In the chemical composition above, a is greater than 0 and may be 0.10 or greater, 0.20 or greater, 0.30 or greater, 0.40 or greater, 0.50 or greater, or 0.60 or greater, and is 1.00 or less and may be 0.90 or less, 0.80 or less, or 0.70 or less. In the chemical composition above, b is 0 or greater and may be 0.01 or greater, 0.02 or greater, or 0.03 or greater, and is 0.20 or less and may be 0.15 or less, or 0.10 or less. In addition, x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. Further, y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. Moreover, z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, an O2-type structure is easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but may be variable without being limited to exactly 2.0.

### 1.1.5 Others

The number of primary particles 1a contained in the active material secondary particle 1 is not particularly limited. In one embodiment, 2 or more, 5 or more, 10 or more, 50 or more, or 100 or more and 10000 or less, 5000 or less, or 1000 or less of the primary particles 1a may be contained in one active material secondary particle 1. Particularly, when the number satisfies the secondary particle diameter described below, higher performance is easily demonstrated.

### 1.2 Li-Ion Conducting Material

As described above, in the active material secondary particle 1, a plurality of primary particles 1a are joined to each other via a Li-ion conducting material 1b. The Li-ion conducting material needs only to be a material that can join a plurality of primary particles 1a to each other and can ensure Li-ion conduction paths between primary particles 1a. The Li-ion conducting material 1b may be an inorganic compound or an organic compound. Particularly, in the case of an inorganic compound, higher performance is easily ensured. The active material secondary particle 1 may be substantially free of organic compounds (content of organic compound at less than 0.01% by mass).

### 1.2.1 Inorganic Compound Having Li-Ion Conducting Properties

The inorganic compound having Li-ion conducting properties, for example, may be at least one selected from a Li-containing oxide and a Li-containing halide. Particularly, in the case of a Li-containing oxide, higher performance is easily ensured.

The Li-containing oxide includes oxides comprising Li and an element A other than Li, for example, may comprise at least one element A selected from B, C, Al, Si, P, S, Ti, La, Zr, Nb, Mo, Zn, and W; Li; and O. The Li-containing oxide may be an oxynitride comprising N. More specifically, the Li-containing oxide may be at least one selected from Li₃BO₃, LiBO₂, Li₂CO₃, LiAlO₂, Li₄SiO₄, Li₂SiO₃, Li₃PO₄, Li₂SO₄, LizTiO₃, Li₄Ti₅O₁₂, Li₂Ti₂O₅, Li₂ZrO₃, LiNbO₃, Li₂MoO₄, LizWO₄, LiPON, Li₂O—LaO₂, and Li₂O—ZnO₂. The Li-containing oxide may have a portion of elements substituted by various doping elements.

The Li-containing halide, for example, may be at least one of various compounds exemplified as a halide solid electrolyte described below. The Li-containing halide, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm; at least one halogen element selected from the group consisting of Cl, Br, I, and F; and Li. The Li-containing halide may comprise at least one selected from the group consisting of Ti, Al, Gd, Ca, Zr, and Y; at least one selected from the group consisting of Cl, Br, I, and F; and Li. The Li-containing halide may comprise at least one element selected from the group consisting of Ti and Al; at least one element selected from the group consisting of Cl, Br, I, and F; and Li. The Li-containing halide, for example, may be a composite halide of Li, Ti, Al, and F.

### 1.2.2 Shape

The shape of the Li-ion conducting material 1b in the active material secondary particle 1 is not particularly limited. In the active material secondary particle 1 according to one embodiment, the Li-ion conducting material 1b can cover the surface of a primary particle 1a. In this case, the coverage (area ratio) of the Li-ion conducting material 1b relative to the surface of a primary particle 1a, for example, may be 50% or greater, 60% or greater, 70% or greater, 80% or greater, or 90% or greater. When the Li-ion conducting material 1b is layered, the thickness of the layer, for example, may be 0.1 nm or more or 1 nm or more, and may be 1 μm or less, 100 nm or less, or 20 nm or less.

### 1.3 Mass Ratio of Li-Ion Conducting Material to Primary Particles

The mass ratio of the Li-ion conducting material 1b to the primary particles 1a in the active material secondary particle 1 is not particularly limited as long as the secondary particle can be maintained. According to the findings of the present inventors, when a ratio M2/M1 of the mass M2 of the Li-ion conducting material 1b relative to the mass M1 of the primary particles 1a contained in the active material secondary particle 1 is 0.01 or greater and 0.20 or less, more satisfactory performance relating to capacity and resistance is easily ensured while the secondary particle is maintained. The ratio M2/M1 may be 0.03 or greater and 0.18 or less, 0.05 or greater and 0.16 or less, or 0.07 or greater and 0.14 or less.

### 1.4 Secondary Particle Diameter

The particle diameter (secondary particle diameter) of the active material secondary particle 1 is not particularly limited. The effect relating to capacity and resistance can be demonstrated regardless of the size of the active material secondary particle 1. According to the findings of the present inventors, when the particle diameter of the active material secondary particle 1 is 2 μm or more and 30 μm or less, 3 μm or more and 25 μm or less, or 5 μm or more and 20 μm or less, granulation of the active material secondary particle 1 is easily carried out, and Li conduction distances inside the active material secondary particle 1 are easily shortened.

The “particle diameter of active material secondary particle” can be determined by observing the exterior of an active material secondary particle 1 with a scanning electron microscope (SEM) or a transmission electron microscope (TEM). Specifically, a two-dimensional image of an active material secondary particle 1 is acquired with SEM, an area of the active material secondary particle 1 contained in the two-dimensional image is determined, the area is converted into a circle to determine an equivalent circular diameter, and the equivalent circular diameter is designated as the “particle diameter of active material secondary particle”.

### 1.5 Others

The active material secondary particle 1 may or may not have voids. Even when the active material secondary particle 1 has voids, by joining fine primary particles 1a to each other with a Li-ion conducting material 1b, as described above, sufficient ion conduction paths and high performance can be ensured.

### 2. Manufacturing Method for Active Material Secondary Particle

The active material secondary particle 1 described above, for example, can be manufactured by the following method. Specifically, the manufacturing method for an active material secondary particle 1 according to one embodiment comprises joining a plurality of primary particles 1a via a Li-ion conducting material 1b to form a secondary particle. The plurality of primary particles 1a have an O2-type structure, and the particle diameter of the plurality of primary particles 1a is 1.5 μm or less.

### 2.1 One Example of Secondary Particle Formation

The method of joining a plurality of primary particles 1a via a Li-ion conducting material 1b to form a secondary particle is not particularly limited. For example, as shown in FIG. 2, by bringing a solution 1bx in which a Li-ion conducting material 1b is dissolved into contact with a plurality of primary particles 1a, the plurality of primary particles 1a can be joined via the Li-ion conducting material 1b to form a secondary particle. Specifically, the manufacturing method for an active material secondary particle 1 according to one embodiment may comprise
preparing a solution 1bx in which a Li-ion conducting material 1b is dissolved, and
bringing the solution 1bx into contact with a plurality of primary particles 1a, followed by drying, thereby joining the plurality of primary particles 1a via the Li-ion conducting material 1b to form a secondary particle. More specifically, the manufacturing method for an active material secondary particle 1 according to one embodiment may comprise
S1: obtaining a slurry comprising a plurality of primary particles 1a and a solution 1bx,
S2: dropletizing the slurry to obtain slurry droplets 1x comprising the plurality of primary particles 1a and the solution 1bx, and
S3: gas-flow drying the slurry droplets 1x in a heated gas to join the plurality of primary particles 1a via a Li-ion conducting material 1b to form a secondary particle.

### 2.1.1 Solution 1bx

When the surface of a primary particle 1a is covered with a Li-containing oxide comprising Li and an element A other than Li, the solution 1bx may comprise a lithium source and an A source. The element A includes at least one selected B, C, Al, Si, P, S, Ti, La, Zr, Nb, Mo, Zn, and W. The solution 1bx may comprise lithium ions as a lithium source. For example, by dissolving a lithium compound such as LiOH, LiNO₃, or Li₂SO₄ in a solvent, a solution 1bx comprising lithium ions as a lithium source may be obtained. Alternatively, the solution 1bx may comprise an alkoxide of lithium as a lithium source. The solution 1bx may comprise a peroxo complex of an element A as an A source. Alternatively, the solution 1bx may comprise an alkoxide of an element A as an A source. For example, when a plurality of primary particles 1a are joined to each other via lithium niobate, the solution 1bx can comprise at least a lithium source and a niobium source. In this case, the solution 1bx, in addition to the lithium source and the niobium source, may comprise at least one of a phosphorus source and a boron source. Alternatively, in place of the niobium source, at least one of a phosphorus source and a boron source may be included. For example, by substituting a portion of Nb in lithium niobate with P (alternatively, doping lithium niobate with P), voltage endurance is easily improved. The molar ratio of the lithium source to the A source contained in the solution 1bx is not particularly limited. For example, the molar ratio Li/A may be 0.5 or greater or 0.8 or greater, and may be 2.0 or less or 1.5 or less. The solvent constituting the solution 1bx needs only to be capable of dissolving the above lithium source, and any of water and organic solvents can be adopted.

### 2.1.2 Slurry

“Slurry” refers to a suspension body or liquid comprising the primary particle 1a and the solution 1bx that needs only to have a fluidity sufficient for dropletization. The slurry may have a fluidity sufficient for dropletization using, for example, a spray nozzle or a rotary atomizer. The solid content concentration of the slurry may be determined in accordance with the type of primary particle 1a, the type of solution 1bx, and the conditions of dropletization (such as the apparatus used for dropletization). The solid content concentration of the slurry is not particularly limited, and for example, may be 1 vol % or greater, 5 vol % or greater, 10 vol % or greater, 20 vol % or greater, 25 vol % or greater, 30 vol % or greater, 35 vol % or greater, 40 vol % or greater, 45 vol % or greater, or 50 vol % or greater, and may be 70 vol % or less, 65 vol % or less, 60 vol % or less, 55 vol % or less, 50 vol % or less, 45 vol % or less, 40 vol % or less, 35 vol % or less, 30 vol % or less, 25 vol % or less, or 20 vol % or less. By adjusting the solid content concentration of the slurry, the particle size of the ultimately obtained active material secondary particle 1 can be controlled.

### 2.1.3 Dropletization of Slurry

“Dropletization” of the slurry means changing the slurry comprising a plurality of primary particles 1a and a solution 1bx into drops (droplets 1x) comprising the plurality of primary particles 1a and the solution 1bx. Additional droplets such as drops containing the solution 1bx only may be generated together with the droplets 1x. The method of dropletizing the slurry comprising a plurality of primary particles 1a and a solution 1bx is not particularly limited. For example, slurry droplets may be obtained by spraying the slurry. When spraying the slurry, a spray nozzle may be used. Examples of methods of spraying the slurry using a spray nozzle include, but are not limited to, a pressurized nozzle method and a two-fluid nozzle method. When spraying the slurry using a spray nozzle, the nozzle diameter is not particularly limited. The nozzle diameter, for example, may be 0.1 mm or more, 0.5 mm or more, or 1 mm or more, and may be 10 mm or less, 5 mm or less, or 1 mm or less. The spray rate (supply rate (feed rate) of the slurry to the spray nozzle) and spray pressure of the slurry are also not particularly limited. The spray rate and the spray pressure may be adjusted in accordance with the viscosity and solid content concentration of the slurry and the nozzle dimensions. By controlling the feed rate of the slurry and the spray pressure, the particle size of the ultimately obtained active material secondary particle 1 can be controlled.

Examples of methods of dropletizing the slurry, in addition to a method of spraying the slurry using a spray nozzle, can also include a method of supplying the slurry onto a rotating disk at a constant rate to dropletize the slurry by centrifugal force. Alternatively, a method of applying a high voltage to the surface of the slurry to dropletize the slurry can be adopted. In the manufacturing method according to one embodiment, for example, a spray dryer may be used to carry out dropletization and gas-flow drying of the slurry. The type of spray dryer is particularly limited, and examples include a type using the above spray nozzle and a type using a rotating disk.

### 2.1.4 Slurry Droplets

As described above, “slurry droplets” can include drops comprising a plurality of primary particles 1a and a solution 1bx (droplets 1x) and drops consisting of the solution 1bx (additional droplets). The size of the slurry droplets is not particularly limited. The diameter (equivalent circular diameter) of the droplets 1x, for example, may be 0.1 μm or more, 0.5 μm or more, 5.0 μm or more, and may be 5000 μm or less, 1000 μm or less, or 500 μm or less. The diameter of the slurry droplets can be measured using, for example, a two-dimensional image obtained by imaging the slurry droplets. Alternatively, the droplet size can be estimated from the operating conditions of the apparatus forming the slurry droplets.

### 2.1.5 Gas-Flow Drying

“Gas-flow drying” means that slurry droplets are dried while being floated in a high-temperature gas flow. The “gas-flow drying” can include not only drying but also ancillary operation using dynamic gas flow. By continuously applying hot air to the slurry droplets by gas-flow drying, a force is continuously applied to the slurry droplets. By controlling the conditions of the gas-flow drying, the particle size of the ultimately obtained active material secondary particle 1 can be controlled.

The temperature of the heated gas may be any temperature as long as the solvent can be volatilized from the slurry droplets. The temperature may be, for example, 100° C. or higher, 110° C. or higher, 120° C. or higher, 130° C. or higher, 140° C. or higher, 150° C. or higher, 160° C. or higher, 170° C. or higher, 180° C. or higher, 190° C. or higher, 200° C. or higher, 210° C. or higher, 220° C. or higher, 230° C. or higher, 240° C. or higher, or 250° C. or higher. Whether or not the surface of the primary particle 1a is covered with the solution 1bx is considered to change significantly depending on the surface energy of the solution 1bx. By setting the heated gas to a high temperature, the temperature of the solution 1bx becomes high, the surface energy of the solution 1bx changes significantly, and the amount of the solution 1bx that can be fixed to the surface of the primary particle 1a may decrease. Specifically, by controlling the temperature of the heated gas, the mass ratio of the Li-ion conducting material 1b to the primary particles 1a of the ultimately obtained active material secondary particle 1 can be controlled.

The gas supply amount (flow rate) of the heated gas can be appropriately set in consideration of the size of the apparatus used and the supply amount of the slurry droplets. For example, the flow rate of the heated gas may be 0.10 m³/min or more, 0.15 m³/min or more, 0.20 m³/min or more, 0.25 m³/min or more, 0.30 m³/min or more, 0.35 m³/min or more, 0.40 m³/min or more, 0.45 m³/min or more, or 0.50 m³/min or more, and may be 5.00 m³/min or less, 4.00 m³/min or less, 3.00 m³/min or less, 2.00 m³/min or less, or 1.00 m³/min or less. The gas supply speed (flow velocity) of the heated gas can be appropriately set in consideration of the size of the apparatus used and the supply amount of the slurry droplets. For example, the flow velocity of the heated gas in at least a portion within the system may be 1 m/s or more or 5 m/s or more, and may be 50 m/s or less or 10 m/s or less.

The treatment time (drying time) with the heated gas can be appropriately set in consideration of the size of the apparatus used and the supply amount of the slurry droplets. For example, the treatment time may be 5 s or less or 1 s or less.

In gas-flow drying, a heated gas that is substantially inert to the primary particle 1a and the solution 1bx may be used. For example, an oxygen-containing gas such as air, an inert gas such as nitrogen or argon, or dry air having a low dew point can be used.

As the apparatus to carry out gas-flow drying, for example, a spray dryer can be used. However, the apparatus is not limited thereto.

### 2.2 Manufacturing Method for Primary Particle

The primary particle 1a having an O2-type structure and having a particle diameter of 1.5 μm or less can be manufactured by, for example, the following method. Specifically, the manufacturing method for the primary particle 1a according to one embodiment comprises
S11: obtaining a precursor (for example, a precursor comprising at least one element among Mn, Ni, and Co),
S12: covering a surface of the precursor with a Na source to obtain a composite,
S13: firing the composite to obtain a Na-containing oxide having a P2-type structure, and
S14: subjecting at least a portion of Na in the Na-containing oxide to ion exchange with Li to obtain a primary particle 1a having an O2-type structure.

The S13 may comprise
S13-1: subjecting the composite to a pre-firing at a temperature of 300° C. or higher and lower than 700° C. for 2 h or more and 10 h or less,
S13-2: following the pre-firing, subjecting the composite to a main firing at a temperature of 700° C. or higher and 1100° C. or lower for 30 min or more and 48 h or less, and
S13-3: following the main firing, rapidly cooling the composite from a temperature T₁ of 200° C. or higher to a temperature T₂ of 100° C. or lower.

### 2.2.1 Production of Precursor

The precursor may comprise at least Mn and one or both of Ni and Co, or may comprise at least Mn, Ni, and Co. The precursor may be a salt comprising at least one element among Mn, Ni, and Co. The precursor, for example, may be at least one of a carbonate, a sulfate, a nitrate, and an acetate. Alternatively, the precursor may be a compound other than a salt. The precursor, for example, may be a hydroxide. The precursor may be a hydrate. The precursor may be a combination of a plurality of compounds. The precursor may be of various shapes. For example, the precursor may be particulate, and may be spherical particles as described below. The particle size of the particles consisting of the precursor is not particularly limited.

In S11, a precipitate as the precursor above may be obtained by a coprecipitation method using an ion source that can form a precipitation with a transition metal ion in an aqueous solution and a transition metal compound comprising at least one element among Mn, Ni, and Co. As a result, spherical particles as the precursor are easily obtained. An “ion source that can form a precipitation with a transition metal ion in an aqueous solution”, for example, may be at least one selected from sodium salts such as sodium carbonate and sodium nitrate, sodium hydroxide, and sodium oxide. The transition metal compound may be a salt or hydroxide described above comprising at least one element among Mn, Ni, and Co. Specifically, in S1, the ion source and the transition metal compound may each be formed into a solution, and the solutions may then be dropped and mixed to obtain a precipitate as the precursor. In this case, for example, water is used as a solvent. In this case, various sodium compounds may be used as a base, and ammonia aqueous solution may be added to adjust basicity. In the case of a coprecipitation method, the precipitate as the precursor is obtained, for example, by preparing an aqueous solution of a transition metal compound and an aqueous solution of sodium carbonate and dropping each to mix the aqueous solutions. Alternatively, it is possible to obtain the precursor by a sol-gel method. Particularly, according to the coprecipitation method, spherical particles as the precursor are easily obtained.

In S11, the precursor may comprise an element M. The element M is at least one selected from B, Mg, Al, K, Ca, Ti, V, Cr, Cu, Zn, Ga, Ge, Sr, Y, Zr, Nb, Mo, and W. These elements M, for example, have a function of stabilizing a P2-type structure and an O2-type structure. The method of obtaining a precursor comprising an element M is not particularly limited. When a precursor is obtained by a coprecipitation method in S1, for example, an aqueous solution of a transition metal compound comprising at least one of Mn, Ni, and Co, an aqueous solution of sodium carbonate, and an aqueous solution of a compound of the element M are prepared, the aqueous solutions are each added dropwise and mixed, whereby a precursor comprising at least one element among Mn, Ni, and Co and the element M is obtained. Alternatively, in the manufacturing method of the present disclosure, the element M is not added in S1, and the element M may be doped when carrying out a Na-doping firing in S2 and S3 described below.

### 2.2.2 Production of Composite

In S12, the surface of the precursor obtained via S11 is covered with a Na source to obtain a composite. The Na source may be a salt comprising Na, such as a carbonate or a nitrate, or may be a compound other than a salt, such as sodium oxide or sodium hydroxide. In S12, the amount of the Na source for covering the surface of the precursor may be determined by taking into account the amount of Na lost during subsequent firing. In S12, the coverage of the Na source relative to the surface of the precursor is not particularly limited. In S12, the method of covering the surface of the above precursor with the Na source is not particularly limited. For example, the precursor and the Na source may be mixed by a mortar or a mixing apparatus, or a solution comprising the Na source may be brought into contact with the precursor using a rolling fluidized coating method or a spray drying method and then dried.

In S12, the precursor may be covered with a Na source and an M source. For example, in S12, the precursor obtained via S1, a Na source, and an M source comprising at least one element selected from B, Mg, Al, K, Ca, Ti, V, Cr, Cu, Zn, Ga, Ge, Sr, Y, Zr, Nb, Mo, and W may be mixed to obtain a composite. The M source, for example, may be a salt comprising an element M, such as a carbonate or a sulfate, or may be a compound other than a salt, such as an oxide or a hydroxide. The amount of the M source relative to the precursor may be determined in accordance with the chemical composition of the Na-containing oxide after firing.

### 2.2.3 Firing of Composite

In S13, the composite obtained via S12 is fired to obtain a Na-containing oxide having a P2-type structure. S13 may comprise the above S13-1, S13-2, and S13-3.

In S13-1, the composite is subjected to a pre-firing at a temperature of 300° C. or higher and lower than 700° C. for 2 h or more and 10 h or less. In S13-1, the pre-firing may be carried out after optionally molding the above composite. The pre-firing is carried out at a temperature lower than that of main firing. When the pre-firing in S13-1 is insufficient, it is possible that generation of a P2 phase in the ultimately obtained Na-containing oxide is insufficient. In S13-1, by setting the pre-firing temperature to 300° C. or higher and lower than 700° C. and the pre-firing time to 2 h or more and 10 h or less, the composite can be subjected to a sufficient pre-firing, heat uniformity is improved, and the Na-containing oxide obtained via S13-2 and S13-3 described below is likely a suitable one. The pre-firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The pre-firing time may be 2 h or more and 8 h or less, 3 h or more and 8 h or less, 4 h or more and 8 h or less, 5 h or more and 8 h or less, or 5 h or more and 7 h or less. The pre-firing atmosphere is not particularly limited, and for example, may be an oxygen-containing atmosphere.

In S13-2, following the above pre-firing, the composite is subjected to a main firing at a temperature of 700° C. or higher and 1100° C. or lower for 30 min or more and 48 h or less. In S13-2, the main firing temperature of the composite may be 800° C. or higher and 1000° C. or lower. When the main firing temperature is too low, a P2 phase is not generated, and when the main firing temperature is too high, an 03 phase, not a P2 phase, is easily generated. The heating conditions from the pre-firing temperature to the main firing temperature is not particularly limited. In S13-2, the shape of the Na-containing oxide can be controlled by the main firing time. When the main firing time is too short, generation of the P2 phase is insufficient. When the main firing time is too long, the P2 phase grows excessively and the particles are coarsened. By adjusting the main firing time, the particle diameter of the primary particles 1a can be controlled to 1.5 μm or less.

In S13-3, following the above main firing, the composite undergoes rapid cooling (cooled at a cooling rate of 20° C./min or higher) from a temperature T₁ of 200° C. or higher to a temperature T₂ of 100° C. or lower. The above pre-firing and main firing are carried out in, for example, a heating furnace. In the step S13-3, for example, the composite is subjected to a main firing in a heating furnace and then cooled to an arbitrary temperature T₁ of 200° C. or higher in the heating furnace, and after reaching the temperature T₁, the fired product is removed from the heating furnace and undergoes rapid cooling outside the furnace to an arbitrary temperature T₂ of 100° C. or lower. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower or may be the cooling end temperature. In the predetermined temperature region from the temperature T₁ until reaching the temperature T₂, moisture easily infiltrates between layers of a P2-type structure by atomic vibrations or molecular motion. When cooling the composite (Na-containing oxide having a P2-type structure) after main firing, by shortening the time in the temperature region where such moisture easily infiltrates (i.e., rapid cooling), it is considered that the infiltration amount of moisture between layers of the P2-type structure is decreased. In this regard, in the step S13-3, when cooling the composite after the main firing, by leaving the composite particles to cool from an arbitrary temperature T₁ of 200° C. or higher until reaching an arbitrary temperature T₂ of 100° C. or lower in, for example, a dry atmosphere outside the furnace, the cooling rate from the temperature T₁ to the temperature T₂ is rapid (for example, 20° C./min or higher), moisture does not easily infiltrate between layers of the P2-type structure, and collapse of the P2-type structure can be inhibited. As a result, Na can efficiently undergo ion exchange with Li in S4.

A Na-containing oxide having a P2-type structure and having a predetermined chemical composition can be manufactured by S13. The Na-containing oxide at least comprises, as constituent elements, at least one transition metal element among Mn, Ni, and Co; Na; and O. Particularly, when the constituent elements at least include Na, Mn, at least one of Ni and Co, and O, especially when the constituent elements include at least Na, Mn, Ni, Co, and O, performance of the positive electrode active material is easily increased. The Na-containing oxide may have a chemical composition represented by Na_{c}Mnₓ₋ₚNi_{y-q}Co_{z-r}M_{p+q+r}O₂, where 0<c<1.00, x+y+z=1, and 0≤p+q+r<0.17. In addition, M is at least one element selected from B, Mg, Al, K, Ca, Ti, V, Cr, Fe, Cu, Zn, Ga, Ge, Sr, Y, Zr, Nb, Mo, and W. When the Na-containing oxide has such a chemical composition, a P2-type structure is more easily maintained. In the above chemical composition, c is greater than 0 and may be 0.10 or greater, 0.20 or greater, 0.30 or greater, 0.40 or greater, 0.50 or greater, or 0.60 or greater, and is less than 1.00 and may be 0.90 or less, 0.80 or less, or 0.70 or less. x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, P2-type and O2-type structures are easily stabilized. In the above chemical composition, p+q+r is 0 or greater, and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but may be variable without being limited to exactly 2.0.

### 2.2.4 Ion Exchange

In S14, by subjecting at least a portion of Na in the Na-containing oxide obtained via S13 to ion exchange with Li, primary particles 1a having an O2-type structure are obtained. Ion exchange includes, for example, a method using an aqueous solution comprising a lithium halide and a method using a mixture (for example, a molten salt) of a lithium halide and an additional lithium salt. From the viewpoint that a P2-type structure is easily broken by water infiltration and the viewpoint of crystallinity, of the above two methods, a method using a molten salt is preferable. Specifically, the above Na-containing oxide having a P2-type structure and the molten salt are mixed and heated to a temperature of the melting point of the molten salt or higher, whereby at least a portion of Na in the Na-containing oxide can be substituted with Li by ion exchange. The lithium halide constituting the molten salt is preferably at least one of lithium chloride, lithium bromide, and lithium iodide. An additional lithium salt constituting the molten salt is preferably lithium nitrate. By using a molten salt, the melting point is lowered compared to when the lithium halide and the additional lithium salt are used independently, and ion exchange at a lower temperature is possible. The temperature of the ion exchange, for example, may be the melting point of the above molten salt or higher and 600° C. or lower, 500° C. or lower, 400° C. or lower, or 300° C. or lower. When the temperature of the ion exchange is too high, an O3-type structure, which is a stable phase, not an O2-type structure, is easily generated. From the viewpoint of shortening the time required for the ion exchange, the temperature of the ion exchange is preferably as high as possible.

### 2.3 Additional Steps

The manufacturing method for an active material secondary particle 1 according to one embodiment, for example, may comprise doping the primary particles 1a constituting the active material secondary particle 1 with Li. As a result, the capacity of the active material secondary particle 1 can be further increased. For example, by bringing a reducing solution comprising Li ions into contact with the primary particles 1a, the primary particles 1a can be doped with Li. A “reducing solution” means a solution having reducing properties, and for example, may be a solution comprising an electrophile. The reducing solution, for example, may be obtained by dissolving an electrophile and a Li source in a solvent. Various organic solvents capable of dissolving an electrophile and a Li source can be adopted as the solvent. For the electrophile, various substances that are dissolved in the above solvent can be adopted. The electrophile may be an aromatic organic compound. For the Li source, various substances that generate Li ions when dissolved in the above solvent can be adopted. The Li source may be metallic lithium or may be a Li compound. The concentrations of the electrophile and the Li ions contained in the reducing solution need only to be appropriately determined in accordance with the target doping amount. According to the findings of the present inventors, the larger the amount of Li ions contained in the reducing solution relative to the amount of the Li-containing transition metal oxide in contact with the reducing solution, the larger the doping amount of Li relative to the Li-containing transition metal oxide tends to be. The molar ratio (electrophile/Li ions) of the electrophile to the Li ions contained in the reducing solution is not particularly limited. The contact form between the reducing solution and the primary particles 1a is not particularly limited. For example, the primary particles 1a may be immersed in the reducing solution, or the reducing solution may be sprayed onto the primary particles 1a. The temperature during contact is not particularly limited, and heating may or may not be carried out. The primary particles 1a may be immersed in the reducing solution and then stirred. The time of the primary particles 1a being brought into contact with the reducing solution is not particularly limited, and needs only to be appropriately determined in accordance with the target doping amount. The timing of doping the primary particles 1a with Li may be before secondary particle formation or after secondary particle formation.

The manufacturing method for an active material secondary particle 1 according to one embodiment may comprise pulverizing the above Na-containing oxide having a P2-type structure and primary particles 1a having an O2-type structure to obtain primary particles 1a having a particle diameter of 1.5 μm or less, and/or classifying the above Na-containing oxide having a P2-type structure and primary particles 1a having an O2-type structure to obtain primary particles 1a having a particle diameter of 1.5 μm or less. Specifically, the particle size of the primary particles 1a may be controlled by the firing conditions of the above Na-containing oxide having a P2-type structure, or may be adjusted by pulverization and classification.

### 3. Electrode Mixture

The active material secondary particle 1, for example, can form an electrode mixture with an additional material. For example, as shown in FIG. 3, the electrode mixture 5 according to one embodiment may comprise the above active material secondary particle 1 of the present disclosure and a solid electrolyte 2. The electrode mixture 5 according to one embodiment may optionally comprise a conductive aid, a binder, and other additives. The content of each of the active material, electrolyte, conductive aid, and binder in the electrode mixture 5 needs only to be appropriately determined in accordance with the target battery performance. For example, when the entire solid content contained in the electrode mixture 5 is 100% by mass, the content of the active material may be 40% by mass or greater and less than 100% by mass, and the content of the solid electrolyte may be greater than 0% by mass and 60% by mass or less. The content of the active material in the electrode mixture 5 may be 50% by mass or greater, 60% by mass or greater, 70% by mass or greater, or 80% by mass or greater, and may be 90% by mass or less. The content of the solid electrolyte may be 10% by mass or greater, and may be 50% by mass or less, 40% by mass or less, 30% by mass or less, or 20% by mass or less. These lower limit values and upper limit values may be arbitrarily combined.

### 3.1 Active Material

The active material contained in the electrode mixture 5 may consist only of the above active material secondary particle 1, or may comprise the active material secondary particle 1 and another active material (additional active material). From the viewpoint of further enhancing the effect of the technique of the present disclosure, the proportion of the additional active material to the entire active material contained in the electrode mixture 5 may be a small amount. For example, when the entirety of the active material contained in the electrode mixture 5 is 100% by mass, the content of the above active material secondary particle 1 may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

For an additional active material that can be contained in the electrode mixture 5, any known active material can be adopted as the additional active material. In the electrode mixture 5, the additional active material, for example, may comprise the above primary particles 1a having an O2-type structure that are not formed into secondary particles. In the electrode mixture 5, the additional active material may comprise at least one selected from various lithium compounds other than that of the primary particle 1a, elemental sulfur, and sulfur compounds. The lithium compound as the additional active material may be a Li-containing oxide comprising at least one element M; Li; and O. The element M, for example, may be at least one selected from Mn, Ni, Co, Al, Mg, Ca, Sc, V, Cr, Cu, Zn, Ga, Ge, Y, Zr, Sn, Sb, W, Pb, Bi, Fe, and Ti, or may be at least one selected from the group consisting of Mn, Ni, Co, Al, Fe, and Ti. More specifically, the Li-containing oxide as the additional active material may be at least one selected from lithium cobaltate, lithium nickelate, lithium manganate, lithium nickel cobaltate, lithium nickel manganate, lithium cobalt manganate, lithium nickel-cobalt-manganese oxide (Li_{1+α}NiₓCo_{y}Mn_{z}O_{2±δ} (for example, 0<x<1, 0<y<1, 0<z<1, and x+y+z=1)), spinel-based lithium compounds (heteroelement-substituted Li—Mn spinels having a composition represented by Li₁₊ₓMn_{2-x-y}MyO₄ (M is one or more selected from Al, Mg, Co, Fe, Ni, and Zn)), lithium nickel-cobalt-aluminum oxide (for example, Li_{1±α}NiₚCo_{q}AlᵣO_{2±δ} (for example, p+q+r=1)), lithium titanate, and lithium metal phosphate (such as LiMPO₄; M is one or more selected from Fe, Mn, Co, and Ni). Particularly, when the additional active material comprises a Li-containing oxide at least comprising, as constituent elements, at least one of Ni, Co, and Mn; Li; and O, higher performance is easily obtained. Alternatively, when the additional active material comprises a Li-containing oxide at least comprising, as constituent elements, at least one of Ni, Co, and Al; Li; and O, higher performance is easily obtained. The additional active material may be of one type used alone, or may be of two or more types used in combination. The shape of the additional active material needs only to be any of general shapes of active materials. The additional active material, for example, may be particulate. The additional active material may be solid, or may have voids therein, for example, may be porous or hollow. The additional active material may be of primary particles, or may be of secondary particles of a plurality of agglomerated primary particles. The average particle diameter D50 of the additional active material, for example, may be 1 nm or more, 5 nm or more, or 10 nm or more, and may be 500 μm or less, 100 μm or less, 50 μm or less, or 30 μm or less.

### 3.2 Electrolyte

The electrode mixture 5 can comprise the above active material secondary particle 1 and an electrolyte. The electrolyte that can be contained in the electrode mixture 5 may be a solid electrolyte, may be a liquid electrolyte, or may be a combination thereof. Particularly, as described above, when the electrode mixture 5 comprises a solid electrolyte, the effect of the technique of the present disclosure is more remarkable.

### 3.2.1 Solid Electrolyte

The solid electrolyte needs only to be any known solid electrolyte for batteries. The solid electrolyte may be an inorganic solid electrolyte or an organic polymer electrolyte. Particularly, an inorganic solid electrolyte has excellent ion-conducting and heat resistance. Examples of inorganic solid electrolytes include oxide solid electrolytes, sulfide solid electrolytes, and inorganic solid electrolytes having ion-binding properties. Particularly, when the electrode mixture 5 comprises a sulfide solid electrolyte as the solid electrolyte, higher performance is easily ensured. The sulfide solid electrolyte, for example, may comprise at least Li, S, and P as constituent elements. Alternatively, the electrode mixture 5 may comprise a solid electrolyte having ion-binding properties as the solid electrolyte, for example, may comprise a solid electrolyte comprising, as constituent elements, at least Li, Y, and a halogen (at least one of Cl, Br, I, and F). The solid electrolyte may be amorphous, or may be crystalline. The solid electrolyte may be particulate. The average particle diameter (D50) of the solid electrolyte, for example, may be 10 nm or more and 10 μm or less. The solid electrolyte may be of one type used alone, or may be of two or more types used in combination.

The oxide solid electrolyte may be one or more selected from lithium lanthanum zirconate, LiPON, Li₁₊ₓAlₓGe₂₋ₓ(PO₄)₃, Li—SiO-based glass, and Li—Al—S—O-based glass. When an oxide solid electrolyte and a liquid electrolyte are combined, ion-conducting properties can be improved.

The sulfide solid electrolyte may be a glass-based sulfide solid electrolyte (sulfide glass), may be a glass-ceramic-based sulfide solid electrolyte, or may be a crystal-based sulfide solid electrolyte. The sulfide glass is amorphous. The sulfide glass may have a glass transition temperature (Tg). When the sulfide solid electrolyte has a crystal phase, examples of the crystal phase include Thio-LISICON-type crystal phase, LGPS-type crystal phase, and argyrodite-type crystal phase. The sulfide solid electrolyte may be particulate. The average particle diameter (D50) of the sulfide solid electrolyte, for example, may be 10 nm or more and 100 μm or less.

The sulfide solid electrolyte, for example, may contain Li element, an X element (X is at least one of P, As, Sb, Si, Ge, Sn, B, Al, Ga, and In), and S element. In addition, the sulfide solid electrolyte may further contain at least one of O element and a halogen element. Further, the sulfide solid electrolyte may contain S element as an anionic element main component.

The sulfide solid electrolyte, for example, may be at least one selected from Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m and n are positive numbers, and Z is any of Ge, Zn, and Ga), Li₂S—GeS₂, Li₂S—SiS₂—Li₃PO₄, and Li₂S—SiS₂-LiₓMO_{y} (where x and y are positive numbers, and M is any of P, Si, Ge, B, Al, Ga, and In).

The composition of the sulfide solid electrolyte is not particularly limited. Examples thereof include xLi₂S·(100−x)P₂S₅(70≤x≤80) and yLiI·zLiBr·(100−y−z) (xLi₂S·(1−x)P₂S₅) (0.7≤x≤0.8, 0≤y≤30, and 0≤z≤30). Alternatively, the sulfide solid electrolyte may have a composition represented by general formula: Li₄₋ₓGe₁₋ₓPₓS₄ (0<x<1). In the above general formula, at least a portion of Ge may be substituted with at least one of Sb, Si, Sn, B, Al, Ga, In, Ti, Zr, V, and Nb. In the above general formula, at least a portion of P may be substituted with at least one of Sb, Si, Sn, B, Al, Ga, In, Ti, Zr, V, and Nb. In the above general formula, a portion of Li may be substituted with at least one of Na, K, Mg, Ca, and Zn. In the above general formula, a portion of S may be substituted with a halogen (at least one of F, Cl, Br, and I). Alternatively, the sulfide solid electrolyte may have a composition represented by Li₇₋ₐPS₆₋ₐXₐ (X is at least one of Cl, Br, and I, and a is a number of 0 or greater and 2 or less). a may be 0, or may be greater than 0. In the latter case, a may be 0.1 or greater, may be 0.5 or greater, or may be 1 or greater. In addition, a may be 1.8 or less, or may be 1.5 or less.

The solid electrolyte having ion-binding properties, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm. These elements can generate cations in water. The ion-binding solid electrolyte material, for example, may comprise at least one halogen element selected from the group consisting of Cl, Br, I, and F. These elements can generate anions in water. The solid electrolyte having ion-binding properties may comprise at least one selected from the group consisting of Gd, Ca, Zr, and Y, at least one selected from the group consisting of Cl, Br, I, and F, and Li. The solid electrolyte having ion-binding properties comprises Li and Y, and may comprise at least one selected from the group consisting of Cl, Br, I, and F. More specifically, the solid electrolyte having ion-binding properties may comprise Li, Y, Cl, and Br, may comprise Li, Ca, Y, Gd, Cl, and Br, or may comprise Li, Zr, Y, and Cl. Even more specifically, the solid electrolyte having ion-binding properties may be at least one of Li₃YBr₂Cl₄, Li_{2.8}Ca_{0.1}Y_{0.5}Gd_{0.5}Br₂Cl₄, and Li_{2.5}Y_{0.5}Zr_{0.5}Cl₆.

The solid electrolyte having ion-binding properties may be a halide solid electrolyte. A halide solid electrolyte has excellent ion-conducting properties. The halide solid electrolyte may have a composition represented by, for example, formula (A):

Li_{α}M_{β}X_{γ} (A)

where α, β, and γ are each independently a value greater than 0, M is at least one selected from the group consisting of metal elements other than Li and semimetal elements, and X is at least one selected from the group consisting of Cl, Br, and I. Note that a “semimetal element” may be at least one selected from the group consisting of B, Si, Ge, As, Sb, and Te. Further, a “metal element” may include (i) all of the elements contained from Group 1 to Group 12 of the periodic table (excluding hydrogen) and (ii) all of the elements contained from Group 13 to Group 16 of the periodic table (excluding B, Si, Ge, As, Sb, Te, C, N, P, O, S, and Se). A metal element can form an inorganic compound with halide ions and form cations.

In the formula (A), M may comprise Y (i.e., yttrium). A halide solid electrolyte comprising Y may have a composition represented by LiₐMe_{b}Y_{c}X₆ (where a+mb+3c=6, c>0, Me is at least one selected from the group consisting of metal elements and semimetal elements other than Li and Y, and m is the valence of Me). Me, for example, may be at least one selected from the group consisting of Mg, Ca, Sr, Ba, Zn, Sc, Al, Ga, Bi, Zr, Hf, Ti, Sn, Ta, and Nb.

The halide solid electrolyte may have a composition represented by formula (A1): Li_{6-3δ}Y_{d}X₆. In the formula (A1), X is one or more elements selected from the group consisting of Cl, Br, and I. d may satisfy 0<d<2, or may be d=1. The halide solid electrolyte may have a composition represented by formula (A2): Li_{3-3δ}Y_{1+δ}Cl₆. In the formula (A2), δ may be 0<δ≤0.15. The halide solid electrolyte may have a composition represented by formula (A3): Li_{3-3δ}Y_{1+δ}Br₆. In the formula (A3), δ may be 0<δ≤0.25. The halide solid electrolyte may have a composition represented by formula (A4): Li_{3-3δ+a}Y_{1+δ+a}MeₐCl_{6-x-y}BrₓI_{y}. In the formula (A4), Me may be at least one selected from the group consisting of Mg, Ca, Sr, Ba, and Zn. In the formula (A4), for example,-1<8<2, 0<a<3, 0< (3-38+a), 0< (1+8-a), 0≤x≤6, 0≤y≤6, and (x+y)≤6 are satisfied. The halide solid electrolyte may have a composition represented by formula (A5): Li_{3-3δ}Y_{1+δ-a}MeₐCl_{6-x-y}BrₓI_{y}. In the formula (A5), Me may be at least one selected from the group consisting of Al, Sc, Ga, and Bi. In the formula (A5), the variables may satisfy −1<δ<1, 0<a<2, 0< (1+δ−α), 0≤x≤6, 0≤y≤6, and (x+y)≤6. The halide solid electrolyte may have a composition represented by formula (A6): Li_{3-3δ-a}Y_{1+δ-a}MeₐCl_{6-x-y}BrₓI_{y}. In the formula (A6), Me may be at least one selected from the group consisting of Zr, Hf, and Ti. In the formula (A6), the variables may satisfy −1<δ<1, 0<a<1.5, 0< (3−3δ−a), 0< (1+δ−a), 0≤x≤6, 0≤y≤6, and (x+y)≤6. The halide solid electrolyte may have a composition represented by formula (A7): Li_{3-3δ-2a}Y_{1+δ-a}MeₐCl_{6-x-y}BrₓI_{y}. In the formula (A7), Me may be at least one selected from the group consisting of Ta and Nb. In the formula (A7), the variables may satisfy −1<δ<1, 0<a<1.2, 0< (3−3δ−2a), 0< (1+δ−a), 0≤x≤6, 0≤y≤6, and (x+y)≤6.

The solid electrolyte having ion-binding properties may be a complex hydride solid electrolyte. The complex hydride solid electrolyte can be composed of Li ions and complex ions comprising H. The complex ion comprising H, for example, may comprise an element M comprising at least one of nonmetal elements, semimetal elements, and metal elements and H bonded to the element M. In the complex ion comprising H, an element M as a central element and H surrounding the element M may be bonded to each other via a covalent bond. The complex ion comprising H may be represented by (MₘHₙ)^{α-}. In this case, m can be any positive number, and n and α can take on any positive number depending on m and the valence of the element M. The element M needs only to be any nonmetal element or metal element that can form a complex ion. For example, the element M may comprise at least one of B, C, and N as a nonmetal element, or may comprise B. Further, for example, the element M may comprise at least one of Al, Ni, and Fe as a metal element. Particularly, when the complex ion comprises B or comprises C and B, higher ion-conducting properties are easily ensured. Specific examples of the complex ion comprising H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. Particularly, when (CB₉H₁₀)⁻, (CB₁₁H₁₂)⁻, or a combination thereof is used, higher ion-conducting properties are easily ensured. Specifically, the complex hydride solid electrolyte may comprise Li, C, B, and H.

### 3.2.2 Liquid Electrolyte

The liquid electrolyte (electrolyte solution) is a liquid comprising lithium ions as carrier ions. The electrolyte solution may be a water-based electrolyte solution or a non-water-based electrolyte solution. The composition of the electrolyte solution needs only to be the same as any known electrolyte solution for lithium-ion secondary batteries. The electrolyte solution may be water or a non-water-based solvent dissolving a lithium salt. Examples of the non-water-based solvent include various carbonate-based solvents. Examples of the lithium salt include lithium amide and LiPF₆.

### 3.3 Conductive Aid

Examples of the conductive aid that can be contained in the electrode mixture 5 include carbon materials such as vapor-grown carbon fiber (VGCF), acetylene black (AB), ketjen black (KB), carbon nanotube (CNT), and carbon nanofiber (CNF); and metal materials such as nickel, titanium, aluminum, and stainless steel. The conductive aid, for example, may be particulate or fibrous, and the size thereof is not particularly limited. The conductive aid may be of one type used alone, or may be of two or more types used in combination.

### 3.4 Binder

Examples of the binder that can be contained in the electrode mixture 5 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 3.5 Others

The electrode mixture 5 may comprise various additives, in addition to the above components, for example, a dispersant or a lubricant.

### 4. Battery

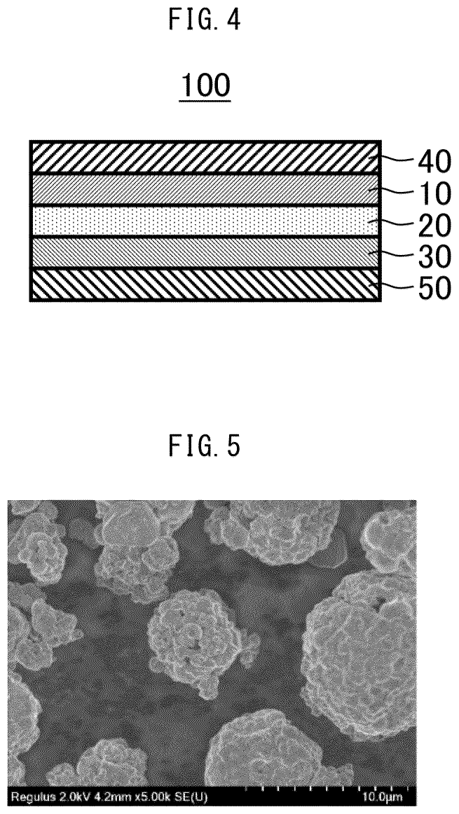

The active material secondary particle 1, for example, can be adopted as a positive electrode active material of a battery. As shown in FIG. 4, the battery 100 according to one embodiment comprises a positive electrode active material layer 10, an electrolyte layer 20, and a negative electrode active material layer 30. The positive electrode active material layer 10 comprises the above active material secondary particle 1 of the present disclosure.

### 4.1 Positive Electrode Active Material Layer

The positive electrode active material layer 10 comprises at least the above active material secondary particle 1 of the present disclosure, and may further optionally comprise an electrolyte, a conductive aid, and a binder. Further, the positive electrode active material layer 10 may additionally comprise various additives. In other words, the positive electrode active material layer 10 can be composed of the above electrode mixture 5. The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

### 4.2 Electrolyte Layer

The electrolyte layer 20 is arranged between the positive electrode active material layer 10 and the negative electrode active material layer 30. The electrolyte layer 20 comprises at least an electrolyte. The electrolyte layer 20 may comprise at least one of a solid electrolyte and an electrolyte solution, and may further optionally comprise a binder. Particularly, when the electrolyte layer 20 comprises a solid electrolyte, higher performance is easily ensured. The contents of the electrolyte and the binder in the electrolyte layer 20 are not particularly limited. Alternatively, the electrolyte layer 20 may comprise a separator for retaining an electrolyte solution and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or more or 1 mm or less.

The electrolyte layer 20 may consist of one layer, or may consist of a plurality of layers. For example, the electrolyte layer 20 may be provided with a first layer arranged on the positive electrode active material layer 10 side and a second layer arranged on the negative electrode active material layer 30 side, wherein the first layer may comprise a first electrolyte and the second layer may comprise a second electrolyte. The first electrolyte and the second electrolyte may be of different types from each other. The first electrolyte and the second electrolyte may each be at least one selected from the above oxide solid electrolytes, sulfide solid electrolytes, and solid electrolytes having ion-binding properties. For example, the first layer may comprise a solid electrolyte having ion-binding properties, and the second layer may comprise at least one of a solid electrolyte having ion-binding properties and a sulfide solid electrolyte.

The electrolyte contained in the electrolyte layer 20 needs only to be appropriately selected from among ones (solid electrolytes and/or liquid electrolytes) exemplified as an electrolyte that can be contained in the positive electrode active material layer 10 (electrode mixture 5) described above. The binder that can be contained in the electrolyte layer 20 needs only to be appropriately selected from among ones exemplified as a binder that can be contained in the positive electrode active material layer described above. The electrolyte and the binder may each be of one type used alone, or may be of two or more types used in combination. The separator needs only to be a commonly used separator in batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 4.3 Negative Electrode Active Material Layer

The negative electrode active material layer 30 comprises at least a negative electrode active material. The negative electrode active material layer 30 may optionally comprise an electrolyte, a conductive aid, a binder, and various additives. The content of each component in the negative electrode active material layer 30 needs only to be appropriately determined in accordance with the target battery performance. For example, when the entire solid content of the negative electrode active material layer 30 is 100% by mass, the content of the negative electrode active material may be 40% by mass or greater, 50% by mass or greater, 60% by mass or greater, or 70% by mass or greater, and may be 100% by mass or less, less than 100% by mass, 95% by mass or less, or 90% by mass or less. Alternatively, when the entire negative electrode active material layer 30 is 100% by volume, the negative electrode active material and optionally the electrolyte, conductive aid, and binder in total may be contained at 85% by volume or greater, 90% by volume or greater, or 95% by volume or greater, and the remaining portion may be voids or additional components. The shape of the negative electrode active material layer 30 is not particularly limited, and for example, may be a sheet having a substantially flat surface. The thickness of the negative electrode active material layer 30 is not particularly limited, and for example, may be 0.1 μm or more, 1 μm or more, 10 μm or more, or 30 μm or more, and may be 2 mm or less, 1 mm or less, 500 μm or less, or 100 μm or less.

Any known negative electrode active material for batteries can be adopted as the negative electrode active material. Of known active materials, various materials having a low electric potential (charge and discharge potentials) for storing and releasing carrier ions compared to the above positive electrode active material can be adopted. For example, silicon-based active materials such as Si, Si alloys, and silicon oxides; carbon-based active materials such as graphite and hard carbon; various oxide-based active materials such as lithium titanate; and metallic lithium and lithium alloys can be adopted. Of these, when the negative electrode active material layer 30 comprises Si as a negative electrode active material, performance of the battery 100 is easily enhanced. The negative electrode active material may be of one type used alone, or may be of two or more types used in combination. The shape of the negative electrode active material needs only to be any general shapes of negative electrode active materials of batteries. For example, the negative electrode active material may be particulate. The negative electrode active material particles may be primary particles, or may be secondary particles of a plurality of agglomerated primary particles. The average particle diameter (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 30 may consist of a sheet of negative electrode active material.

The electrolyte that can be contained in the negative electrode active material layer 30, for example, includes the solid electrolytes and electrolyte solutions described above, and combinations thereof. The conductive aid that can be contained in the negative electrode active material layer 30, for example, needs only to be appropriately selected from among ones exemplified as a conductive aid that can be contained in the positive electrode active material layer 10 (electrode mixture 5) described above. The binder that can be contained in the negative electrode active material layer 30, for example, needs only to be appropriately selected from among one exemplified as a binder that can be contained in the positive electrode active material layer 10 (electrode mixture 5) described above. The electrolyte, the conductive aid, and the binder may each be of one type used alone, or may be of two or more types used in combination.

### 4.4 Positive Electrode Current Collector

As shown in FIG. 4, the battery 100 may be provided with a positive electrode current collector 40 in contact with the positive electrode active material layer 10. Any general positive electrode current collector for batteries can be adopted as the positive electrode current collector 40. The positive electrode current collector 40 may have at least one shape selected from foil-like, tabular, mesh-like, punched metal-like, and a foam. The positive electrode current collector 40 may be composed of a metal foil or a metal mesh. Particularly, a metal foil has excellent handleability. The positive electrode current collector 40 may consist of a plurality of foils. Examples of metals constituting the positive electrode current collector 40 include at least one selected from Cu, Ni, Cr, Au, Pt, Ag, Al, Fe, Ti, Zn, Co, V, Mg, Pg, Ge, In, Sn, Zr, and stainless steel. Particularly, from the viewpoint of ensuring oxidation resistance, the positive electrode current collector 40 may comprise Al. The positive electrode current collector 40 may have on the surface thereof some coating layer for the purpose of adjusting resistance. For example, the positive electrode current collector 40 may have a carbon coating layer. The positive electrode current collector 40 may be a metal foil or substrate plated or vapor-deposited with a metal described above. When the positive electrode current collector 40 consists of a plurality of metal foils, there may be some layer between the plurality of metal foils. The thickness of the positive electrode current collector 40 is not particularly limited, and for example, may be 0.1 μm or more or 1 μm or more, and may be 1 mm or less or 100 μm or less.

### 4.5 Negative Electrode Current Collector

As shown in FIG. 4, the battery 100 may be provided with a negative electrode current collector 50 in contact with the negative electrode active material layer 30. Any general negative electrode current collector for batteries can be adopted as the negative electrode current collector 50. The negative electrode current collector 50 may be foil-like, tabular, mesh-like, punched metal-like, or a foam. The negative electrode current collector 50 may be a metal foil or a metal mesh, and alternatively, may be a carbon sheet. Particularly, a metal foil has excellent handleability. The negative electrode current collector 50 may consist of a plurality of foils or sheets. Metals constituting the negative electrode current collector 50 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of ensuring reduction resistance and the viewpoint of making alloying with lithium difficult, the negative electrode current collector 50 may comprise at least one metal selected from Cu, Ni, and stainless steel. The negative electrode current collector 50 may have on the surface thereof some coating layer for the purpose of adjusting resistance. For example, the negative electrode current collector 50 may have a carbon coating layer. The negative electrode current collector 50 may be an aluminum foil having a carbon coating layer. The negative electrode current collector 50 may be a metal foil or a substrate plated or vapor-deposited with a metal described above. When the negative electrode current collector 50 consists of a plurality of metal foils, there may be some layer between the plurality of metal foils. The thickness of the negative electrode current collector 50 is not particularly limited, and for example, may be 0.1 μm or more or 1 μm or more, and may be 1 mm or less or 100 μm or less.

### 4.6 Additional Configurations

The battery 100, in addition to the above configurations, may be provided with any general configuration as a battery, for example, tabs or terminals. The above configurations of the battery 100 may each be housed inside an outer packaging. Any known outer packaging can be adopted as the outer packaging of the battery. In addition, a plurality of batteries 100 may be optionally connected electrically and optionally stacked to form a battery pack. In this case, the battery pack may be housed inside a known battery case. Examples of shapes of the battery 100 can include coin-type, laminate-type, cylindrical, and rectangular. The battery 100 may be a secondary battery.

The battery 100 can be manufactured by applying any known method, except that the above specific active material secondary particle 1 is used, and for example, can be manufactured as follows. However, the manufacturing method for the battery 100 is not limited to the following method. For example, each layer may be formed by dry molding.

(1) An active material secondary particle 1 constituting a positive electrode active material layer is dispersed in a solvent to obtain a positive electrode layer slurry. The solvent used in this case is not particularly limited, and water and various organic solvents can be used. The positive electrode layer slurry is then applied on a surface of a positive electrode current collector using a doctor blade, followed by drying, whereby a positive electrode active material layer is formed on the surface of the positive electrode current collector to obtain a positive electrode.

(2) A negative electrode active material constituting a negative electrode active material layer is dispersed in a solvent to obtain a negative electrode layer slurry. The solvent used in this case is not particularly limited, and water and various organic solvents can be used. The negative electrode layer slurry is then applied on a surface of a negative electrode current collector using a doctor blade, followed by drying, whereby a negative electrode active material layer is formed on the surface of the negative electrode current collector to obtain a negative electrode.

(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.

(4) The laminated body is housed in a battery case, and in the case of an electrolyte solution battery, the battery is filled with an electrolyte solution inside the battery case so that the laminated body is immersed in the electrolyte solution, and then the laminated body is sealed within the battery case, whereby a secondary battery is obtained. Note that in the case of an electrolyte solution battery, the electrolyte solution may be contained in the negative electrode active material layer, the separator, and the positive electrode active material layer in step (3) above.

### 5. Vehicle

The battery of the present disclosure has high capacity and low resistance by using the active material secondary particle 1. Such a battery, for example, can be suitably used in at least one type of vehicle selected from hybrid vehicle (HEV), plug-in hybrid vehicle (PHEV), and battery electric vehicle (BEV). Specifically, the technique of the present disclosure has an aspect of a vehicle comprising a battery, wherein the battery comprises a positive electrode active material layer, an electrolyte layer, and a negative electrode active material layer, and the positive electrode active material layer comprises the above active material secondary particle 1 of the present disclosure.

### EXAMPLES

From the foregoing, one embodiment of the active material secondary particle has been described. However, various modifications to the technique of the present disclosure other than the above embodiments are possible without departing from the spirit thereof. Hereinafter, the technique of the present disclosure will be further described in detail with reference to the Examples. However, the technique of the present disclosure is not limited to the following Examples.

### 1. PRODUCTION OF PRIMARY PARTICLE

### 1.1 Production of Precursor

### 1.1.1 Examples 1 to 7 and Comparative Examples 1 to 5

(1) MnSO₄·5H₂O, NiSO₄·6H₂O, and CoSO₄·7H₂O were weighed to a target compositional ratio (Mn:Ni:Co=5:2:3) and dissolved in distilled water to a concentration of 1.2 mol/L to obtain a first solution. In a separate container, Na₂CO₃ was dissolved in distilled water to a concentration of 1.2 mol/L to obtain a second solution.

(2) 1000 mL of pure water was loaded into a reactor (with baffles), and 500 mL of the first solution and 500 mL of the second solution were each added therein dropwise at a rate of about 4 mL/min.

(3) Upon completion of the dropwise addition, stirring was carried out a stirring rate of 150 rpm at room temperature for 1 h to obtain a product.

(4) The product was washed with pure water and subjected to solid-liquid separation with a centrifugal separator to recover a precipitate.

(5) The resulting precipitate was dried overnight at 120° C. and pulverized with a mortar, coarse particles and fine particles were separated by airflow classification, the fine particles were removed, and the coarse particles as precursor particles were obtained.

### 1.1.2 Example 8

Except that the compositional ratio of Mn, Ni, and Co in the precursor was adjusted to Mn:Ni:Co=4:2:4, precursor particles were obtained in the same manner as in Examples 1 to 7 and Comparative Examples 1 to 5.

### 1.1.3 Example 9

Except that the compositional ratio of Mn, Ni, and Co in the precursor was adjusted to Mn:Ni:Co=3:3:4, precursor particles were obtained in the same manner as in Examples 1 to 7 and Comparative Examples 1 to 5.

### 1.2 Production of Composite

### 1.2.1 Examples 1 to 9 and Comparative Examples 1, 4, and 5

The precursor particles and Na₂CO₃ were weighed so as to have a composition of Na_{0.8}Mn_{0.5}Ni_{0.2}Co_{0.3}O₂ after the firing described below and mixed using a mortar to cover the surfaces of the precursor particles with Na₂CO₃ to obtain a composite.

### 1.2.2 Comparative Examples 2 and 3

(1) Na₂CO₃ and distilled water were weighed to 1150 g/L and then stirred until complete dissolution using a stirrer to produce a Na₂CO₃ aqueous solution.

(2) The above Na₂CO₃ aqueous solution and the above precursor particles were weighed so as to have a composition of Na_{0.8}Mn_{0.5}Ni_{0.2}Co_{0.3}O₂ after the firing described below and mixed to obtain a slurry.

(3) The above slurry was gas-flow dried by spray drying to obtain a composite. Specifically, using a spray drying apparatus DL410, under the conditions of a slurry feed rate of 30 mL/min, an inlet temperature of 200° C., a circulating air volume of 0.8 m³/min, and a spraying air pressure of 0.3 MPa, the above slurry was gas-flow dried to cover the surfaces of the precursor particles with Na₂CO₃ to obtain a composite.

### 1.3 Firing of Composite

The composite was loaded into an alumina crucible and fired under an ambient air atmosphere to obtain a Na-containing oxide having a P2-type structure. The firing conditions were as described in the following (1) to (5).

(1) An alumina crucible containing above composite was set in a heating furnace in an ambient air atmosphere.
(2) Temperature inside the heating furnace was raised from room temperature (25° C.) to 600° C. in 115 min.

(3) Temperature inside the heating furnace was kept at 600° C. for 360 min to carry out pre-firing.

(4) After pre-firing, temperature inside the heating furnace was raised to 900° C. and kept at 900° C. for 60 min to carry out main firing.

(5) After main firing, temperature inside the heating furnace was lowered from the main firing temperature to 250° C., the alumina crucible was removed from the heating furnace at 250° C., and was left to cool outside the furnace in a dry atmosphere to reach 25° C. in 10 min.

The fired product after leaving to cool was pulverized using a mortar under a dry atmosphere to obtain Na-containing oxide particles (P2-type particles) having a P2-type structure.

### 1.4 Ion Exchange

(1) LiNO₃ and LiCl were weighed to a molar ratio of 50:50 and mixed with the above P2-type particles at a molar ratio 10 times the minimum Li amount required for ion exchange to obtain a mixture.

(2) An alumina crucible was used to carry out ion exchange at 280° C. for 1 h under an ambient air atmosphere to obtain a product comprising a Li-containing oxide.

(3) Salt remaining in the product was washed away with pure water and the product was subjected to solid-liquid separation by vacuum filtration to obtain a precipitate.

(4) The resulting precipitate was dried overnight at 120° C. to obtain primary particles of a Li-containing oxide having an O2-type structure.

### 2. SECONDARY PARTICLE FORMATION

(1) A Li source and a Nb source were dissolved in water to obtain a solution.

(2) The above primary particles were mixed in the solution to obtain a slurry.

(3) The slurry was sprayed and dried by spray drying and further dried overnight at 120° C. to obtain intermediate particles comprising the primary particles and a Li-containing oxide (composite oxide of Li and Nb) as the Li-ion conducting material. By adjusting the spray drying conditions (slurry feed rate, slurry solid content ratio, and spraying air pressure), the presence of granules in the intermediate particles and the particle size of the intermediate particles were adjusted.

### 3. Li DOPING

(1) Biphenyl was mixed and dissolved in tetrahydrofuran (THF) to 1 mol/L inside a glove box (Ar atmosphere) to obtain a biphenyl solution.

(2) Li foil at the same number of moles as the biphenyl was added in the biphenyl solution and stirred for 2 h to obtain a reducing solution comprising 1 mol/L of Li ions.

(3) The above intermediate particles were added, immersed, and stirred in the obtained reducing solution for 24 h, wherein the addition amount of intermediate particles was adjusted so that the ratio of the number of moles of dissolved Li ions relative to the number of moles of intermediate particles (Li/O₂) was 0.35.

(4) The intermediate particles after stirring were washed with THF and subjected to solid-liquid separation by vacuum filtration. The resulting precipitate was dried overnight at 120° C. to obtain active material particles for evaluation. The molar ratios of Mn, Ni, and Co contained in the active material particles are described in Tables 1 to 3 below. The crystal phase contained in the active material particles was confirmed by XRD, where it was found that the active material particles had an O2-type structure.

### 4. OBSERVATION OF ACTIVE MATERIAL PARTICLE FORM

The form of the active material particles was observed by SEM. For each of Examples 1 to 9 and Comparative Examples 1 to 5, the “Shape (tabular, spherical, indeterminate) of primary particles constituting the active material particles”, “Particle diameter of the primary particles”, “Presence of granulation (secondary particle formation) in the active material particles”, “Particle diameter of the active material particles as secondary particles”, and “Ratio M2/M1 of mass M2 of Li-ion conducting material relative to mass M1 of primary particles” are shown in Tables 1 to 3 below. For reference, FIG. 5 shows a SEM image of the exterior of the active material particles of Example 6.

### 5. CHARGE-DISCHARGE CHARACTERISTICS EVALUATION

(1) The active material particles described above, a sulfide-based solid electrolyte, vapor-grown carbon fiber (VGCF), a PVdF-based binder, and butyl butyrate were stirred by an ultrasonic dispersion apparatus to obtain a positive electrode slurry. The mass ratio of active material particles:sulfide-based solid electrolyte:VGCF:PVdF-based binder was 81.1:15.9:2.4:0.6. The positive electrode slurry was applied onto an Al foil acting as a positive electrode current collector by a blade method, and this was dried on a hot plate at 100° C. for 30 min to form a positive electrode active material layer on an Al foil.

(2) Lithium titanium oxide (LTO) as a negative electrode active material, a sulfide-based solid electrolyte, VGCF, a PVdF-based binder, and butyl butyrate were stirred by an ultrasonic dispersion apparatus to obtain a negative electrode slurry. The mass ratio of negative electrode active material: sulfide-based solid electrolyte:VGCF:PVdF-based binder was 72.1:22.7:1.7:3.5. The negative electrode slurry was applied onto a Ni foil acting as a negative electrode current collector by a blade method, and this was dried on a hot plate at 100° C. for 30 min to form a negative electrode active material layer on a Ni foil.

(3) A sulfide-based solid electrolyte, a PVdF-based binder, and butyl butyrate were stirred by an ultrasonic dispersion apparatus to obtain a solid electrolyte slurry. The mass ratio of the sulfide-based solid electrolyte to the PVdF-based binder was 99.4:0.6. The solid electrolyte slurry was applied onto an Al foil acting as a substrate by a blade method, and this was dried on a hot plate at 100° C. for 30 min to obtain a peelable solid electrolyte layer.

(4) The above positive electrode active material layer and solid electrolyte layer were laminated and pressed with a roll press at a press pressure of 50 kN/cm and a temperature of 160° C., and then the Al foil was peeled from the solid electrolyte layer and the laminate was punched out to a size of 1 cm², thereby obtaining a positive electrode laminated body.

(5) The above negative electrode active material layer and solid electrolyte layer were laminated and pressed with a roll press at a press pressure of 50 kN/cm and a temperature of 160° C., and then the Al foil was peeled from the solid electrolyte layer to obtain a negative electrode laminated body. Further, an additional solid electrolyte layer was laminated to the solid electrolyte side of the negative electrode laminated body above and pre-pressed with a flat uniaxial press at a pressure of 100 MPa and a temperature of 25° C., and then the Al foil was peeled from the solid electrolyte layer and the laminate was punched out to a size of 1.08 cm² thereby obtaining a negative electrode laminated body having an additional solid electrolyte layer.

(6) The positive electrode laminated body above and the negative electrode laminated body having an additional solid electrolyte layer were laminated so that the mixture surfaces overlapped, and were pressed with a flat uniaxial press at a press pressure of 200 MPa and a temperature of 120° C. to obtain a battery laminated body.

(7) The battery laminated body above were interposed between two restraining plates, the two restraining plates were fastened by a fastener at a restraining pressure of 5 MPa to fix the distance between the two restraining plates, and an evaluation cell was obtained.

(8) The evaluation cell underwent constant current charging at 1/10 C to 3.25 V, followed by constant voltage charging at 3.25 V to a final current of 1/100 C, and further underwent constant current discharging at 1/10 C to 0.45 V, followed by constant voltage discharging at 0.45 V to a final current of 1/100 C. The initial discharge capacity was measured.

(9) The evaluation cell further underwent constant current charging at 1/10 C to 2.2 V, followed by constant voltage charging at 2.2 V to a final current of 1/100 C to regulate the charge state. The evaluation cell after regulating the charge state was flowed with a current equivalent to 3 C for 10 s, and the resistance value was measured by dividing the voltage change before and after the current flow by the current value. The resistance value in Example 1 was set to 100 to normalize the resistance value of other Examples.

For each of the cells of Examples 1 to 9 and Comparative Examples 1 to 5, “Initial discharge capacity” and “Normalized resistance value” are shown in Tables 1 to 3 below.

TABLE 1
Presence of Secondary

| | | | Primary | | | | Initial | |
|---|---|---|---|---|---|---|---|---|
| | | Primary | particle | | Secondary | | discharge | Normalized |
| | | particle | diameter | Presence of | particle diameter | M2/ | capacity | resistance |
| | Mn:Ni:Co | shape | (μm) | granulation | (μm) | M1 | (mAh/g) | value |
| Example 1 | 5:2:3 | tabular + | 0.1 | yes | 20 | 0.05 | 218 | 100 |
| | | indeterminate | | | | | | |
| Example 2 | 5:2:3 | tabular + | 0.5 | yes | 20 | 0.05 | 219 | 103 |
| | | indeterminate | | | | | | |
| Example 3 | 5:2:3 | tabular + | 1.0 | yes | 20 | 0.05 | 217 | 110 |
| | | indeterminate | | | | | | |
| Comparative | 5:2:3 | tabular + | 2.0 | yes | 20 | 0.05 | 218 | 148 |
| Example 1 | | indeterminate | | | | | | |
| Comparative | 5:2:3 | spherical + | 2.0 | no | — | 0.05 | 195 | 110 |
| Example 2 | | indeterminate | | | | | | |
| Comparative | 5:2:3 | spherical + | 2.0 | yes | 20 | 0.05 | 192 | 194 |
| Example 3 | | indeterminate | | | | | | |
| Comparative | 5:2:3 | tabular + | 2.0 | no | — | 0.05 | 220 | 181 |
| Example 4 | | indeterminate | | | | | | |
| Comparative | 5:2:3 | tabular + | 0.1 | no | — | 0.05 | 184 | 223 |
| Example 5 | | indeterminate | | | | | | |

TABLE 2

| | | | Primary | | | | Initial | |
|---|---|---|---|---|---|---|---|---|
| | | Primary | particle | | Secondary | | discharge | Normalized |
| | | particle | diameter | Presence of | particle diameter | M2/ | capacity | resistance |
| | Mn:Ni:Co | shape | (μm) | granulation | (μm) | M1 | (mAh/g) | value |
| Example 4 | 5:2:3 | tabular + | 0.1 | yes | 30 | 0.05 | 213 | 113 |
| | | indeterminate | | | | | | |
| Example 1 | 5:2:3 | tabular + | 0.1 | yes | 20 | 0.05 | 218 | 100 |
| | | indeterminate | | | | | | |
| Example 5 | 5:2:3 | tabular + | 0.1 | yes | 10 | 0.05 | 220 | 94 |
| | | indeterminate | | | | | | |
| Example 6 | 5:2:3 | tabular + | 0.1 | yes | 5 | 0.05 | 221 | 90 |
| | | indeterminate | | | | | | |
| Example 7 | 5:2:3 | tabular + | 0.1 | yes | 2 | 0.05 | 221 | 119 |
| | | indeterminate | | | | | | |

TABLE 3

| | | | Primary | | | | Initial | |
|---|---|---|---|---|---|---|---|---|
| | | Primary | particle | | Secondary | | discharge | Normalized |
| | | particle | diameter | Presence of | particle diameter | M2/ | capacity | resistance |
| | Mn:Ni:Co | shape | (μm) | granulation | (μm) | M1 | (mAh/g) | value |
| Example 8 | 4:2:4 | tabular + | 0.1 | yes | 20 | 0.05 | 229 | 97 |
| | | indeterminate | | | | | | |
| Example 9 | 3:3:4 | tabular + | 0.1 | yes | 20 | 0.05 | 220 | 101 |
| | | indeterminate | | | | | | |

From the results shown in Tables 1 to 3, the following was found.

From the results of Examples 1 to 3 and Comparative Examples 1 to 4 in Table 1, it was found that when the primary particle diameter was 2.0 μm or more, the normalized resistance value increased significantly. It is presumed that when the primary particle diameter was 2.0 μm or more, although granulation itself was possible, the diffusion distance inside the bulk of the primary particles was lengthened, thereby causing an increase in diffusion resistance, a decrease in reaction area, and an increase in reaction resistance.

From the results of Examples 1 to 3 and Comparative Examples 2 and 3 in Table 1, the initial charge and discharge capacities were increased when the primary particles comprised tabular particles than when the primary particles comprised spherical particles. Spherical particles may have voids present therein, whereby the utilization rate of the active material inside the particles may have decreased.

From the results of Examples 1 to 3 and Comparative Examples 4 and 5 in Table 1, it was found that when primary particles were not formed into secondary particles, the normalized resistance value increased significantly. This is presumably because an increase in diffusion resistance due to a lengthened diffusion distance inside the bulk, an increase in reaction resistance due to a decrease in reaction area, and the lack of secondary particle formation decreased the degree of tortuosity of Li diffusion within the electrodes, thereby increasing diffusion resistance.

From the results of Comparative Example 5 in Table 1, it was found that when fine primary particles were used without forming into secondary particles, the initial charge and discharge capacities were decreased. This is presumably because during the electrode production step, the fine primary particles agglomerated while including voids, and ensuring Li-ion conduction paths within the agglomeration became difficult.

From the results of Examples 4 to 7 in Table 2, it was found that the effect of forming primary particles into secondary particles via a Li-ion conducting material could be obtained regardless of the particle size of the secondary particles.

From the results of Examples 8 and 9 in Table 3, it was found that the effect of forming primary particles into secondary particles via a Li-ion conducting material could be obtained regardless of the chemical composition of the primary particles having an O2-type structure.

### 6. CONCLUSION

From the above results, it can be said that according to the following active material secondary particle, high capacity and low resistance can both be achieved.

An active material secondary particle, comprising a plurality of primary particles and a Li-ion conducting material, wherein
the plurality of primary particles have an O2-type structure,
a particle diameter of the plurality of primary particles is 1.5 μm or less, and
the plurality of primary particles are joined to each other via the Li-ion conducting material.

### REFERENCE SIGNS LIST

1 active material secondary particle
1a primary particle
1b Li-ion conducting material
5 electrode mixture
2 solid electrolyte
100 battery
10 positive electrode active material layer
20 electrolyte layer
30 negative electrode active material layer
40 positive electrode current collector
50 negative electrode current collector

1. An active material secondary particle, comprising a plurality of primary particles and a Li-ion conducting material, wherein
the plurality of primary particles have an O2-type structure,
a particle diameter of the plurality of primary particles is 1.5 μm or less, and
the plurality of primary particles are joined to each other via the Li-ion conducting material.

2. The active material secondary particle according to claim 1, wherein
a ratio M2/M1 of a mass M2 of the Li-ion conducting material relative to a mass M1 of the primary particles is 0.01 or greater and 0.20 or less.

3. The active material secondary particle according to claim 1, wherein
at least a portion of the plurality of primary particles are tabular particles.

4. The active material secondary particle according to claim 1, wherein
a particle diameter of the active material secondary particle is 3 μm or more and 25 μm or less.

5. The active material secondary particle according to claim 1, wherein
the Li-ion conducting material is an inorganic compound.

6. The active material secondary particle according to claim 5, wherein
the inorganic compound is a Li-containing oxide.

7. An electrode mixture, comprising
the active material secondary particle according to claim 1, and
a solid electrolyte.

8. The electrode mixture according to claim 7, wherein
the solid electrolyte comprises a sulfide solid electrolyte.

9. A battery, comprising a positive electrode active material layer, an electrolyte layer, and a negative electrode active material layer, wherein
the positive electrode active material layer comprises the active material secondary particle according to claim 1.

10. The battery according to claim 9, wherein
the electrolyte layer comprises a solid electrolyte.

11. A manufacturing method for an active material secondary particle, comprising
joining a plurality of primary particles via a Li-ion conducting material to form a secondary particle, wherein
the plurality of primary particles have an O2-type structure, and
a particle diameter of the plurality of primary particles is 1.5 μm or less.

12. The manufacturing method for an active material secondary particle according to claim 11, comprising
preparing a solution in which the Li-ion conducting material is dissolved, and
bringing the solution into contact with the plurality of primary particles, followed by drying, thereby joining the plurality of primary particles via the Li-ion conducting material to form a secondary particle.
